(19) United States
(12) Patent Application Publication
(10) Pub. No.: US 2005/0083191 A1
(43) Pub. Date: Apr. 21, 2005

(54) U-turn and slowing to stop signals

(76) Inventor: Lenora K. Levin, Dallas, TX (US)

Correspondence Address: W. Thomas Timmons;The White House on Turtle Creek, 2401 Turtle Creek Blvd, Dallas, TX, 75219-4760, US

(21) Appl. No.: 10/687,028

(22) Filed: Oct. 16, 2003

(51) Int. Cl. B60Q 1/34

(52) U.S. Cl. 340/475

(57) ABSTRACT

A turn signal device, according to the present invention, for use on a vehicle having a turn signal, includes a human operated signal initiation device, at least one flasher; and at least one delay device. The at least one flasher and the at least one delay device are connected in a circuit which is responsive to the human operated signal initiation device. The vehicle turn signal is responsive to the circuit, and the circuit causes the vehicle turn signal to operate in a manner easily distinguishable from a conventional turn signal. In one arrangement, the circuit causes the vehicle turn signal to operate in a combination of long and short light signals. In a similar arrangement, the circuit causes the vehicle turn signal to operate in a combination of long and short light signals and a combination of long and short delays between the light signals. In general, the circuit causes the vehicle turn signal to operate in a series of light signals and delays. In a preferred form, wherein the circuit causes the vehicle turn signal to operate in a repeated series of two short light signals followed by one long light signal, with short delays after the short light signals and a long delay after the long light signal. Such a signal represents the letter “U” in Morse Code. A similar code could be used for a slow-to-stop signal. In general, the U-turn signal would be on the front and rear driver side turn signal and the slow-to-stop or pull-over-to-stop signal would be on the front and rear passenger side. In one particular embodiment, the at least one flasher comprises two short flashers and one long flasher in series. In one such embodiment, the at least one delay device comprises a short delay device in series with and after each of the two short flashers and a long delay device after the one long flasher. Normally, the long flasher is at least twice as long as a short flasher and the long delay device delays at least twice as long as a short delay device.

### BACKGROUND OF THE INVENTION

1. Field of the Invention

The present invention relates generally to vehicle turn signals, and in particular, to signals for U-turns and slowing to stop.

2. Description of Related Art

Most prior U-turn devices were mainly additional lights, either added as aftermarket devices or included in the original vehicle. Some, like U.S. Pat. Nos. 4,387,361; 5,003,289 and 6,195,001 show a signal mounted inside a car to be visible through a window. U.S. Pat. No. 5,680,100 includes a separate U-shaped lens over a separate signal light. U.S. Pat. Nos. 5,731,755 and 6,043,740 show the use of a series of lights that flash in a sequence to make a U-shape.

U.S. Pat. No. 5,663,708 adds additional colored lights to existing left turn signals.

### SUMMARY OF THE INVENTION

A turn signal device, according to the present invention, for use on a vehicle having a turn signal, includes a human operated signal initiation device, at least one flasher; and at least one delay device. The at least one flasher and the at least one delay device are connected in a circuit which is responsive to the human operated signal initiation device. The vehicle turn signal is responsive to the circuit, and the circuit causes the vehicle turn signal to operate in a manner easily distinguishable from a conventional turn signal. In one arrangement, the circuit causes the vehicle turn signal to operate in a combination of long and short light signals. In a similar arrangement, the circuit causes the vehicle turn signal to operate in a combination of long and short light signals and a combination of long and short delays between the light signals. In general, the circuit causes the vehicle turn signal to operate in a series of light signals and delays. In a preferred form, wherein the circuit causes the vehicle turn signal to operate in a repeated series of two short light signals followed by one long light signal, with short delays after the short light signals and a long delay after the long light signal. Such a signal represents the letter “U” in Morse Code. A similar code could be used for a slow-to-stop signal. In general, the U-turn signal would be on the front and rear driver side turn signal and the slow-to-stop or pull-over-to-stop signal would be on the front and rear passenger side. In one particular embodiment, the at least one flasher comprises two short flashers and one long flasher in series. In one such embodiment, the at least one delay device comprises a short delay device in series with and after each of the two short flashers and a long delay device after the one long flasher. Normally, the long flasher is at least twice as long as a short flasher and the long delay device delays at least twice as long as a short delay device.

In more generalized terms, a turn signal device, according to the present invention, for use on a vehicle having a turn signal, includes a human operated signal initiation device, at least one flasher device responsive to the human operated signal initiation device. The vehicle turn signal is responsive to the at least one flasher device, operating in a manner easily distinguishable from a conventional turn signal. The at least one flasher device causes the vehicle turn signal to operate in a combination of long and short light signals. In one arrangement, the at least one flasher device causes the vehicle turn signal to operate in a combination of long and short light signals and a combination of long and short delays between the light signals, but in general, the at least one flasher device causes the vehicle turn signal to operate in a series of light signals and delays. Again, in a preferred form, the at least one flasher device causes the vehicle turn signal to operate in a repeated series of two short light signals followed by one long light signal, with short delays after the short light signals and a long delay after the long light signal.

These and other objects, advantages and features of this invention will be apparent from the following description taken with reference to the accompanying drawing, wherein is shown a preferred embodiment of the invention.

### BRIEF DESCRIPTION OF THE DRAWING

FIG. 1 is a block diagram representation of a turn signal circuit according to the present invention;

FIG. 2 is a symbolic representation of a steering column and turn signal initiation device according to the present invention;

FIG. 3 is a flow diagram representation of a flasher device according to the present invention; and

FIG. 4 is a flow diagram representation of an alternative embodiment of a flasher device according to the present invention.

### DESCRIPTION OF THE PREFERRED EMBODIMENT

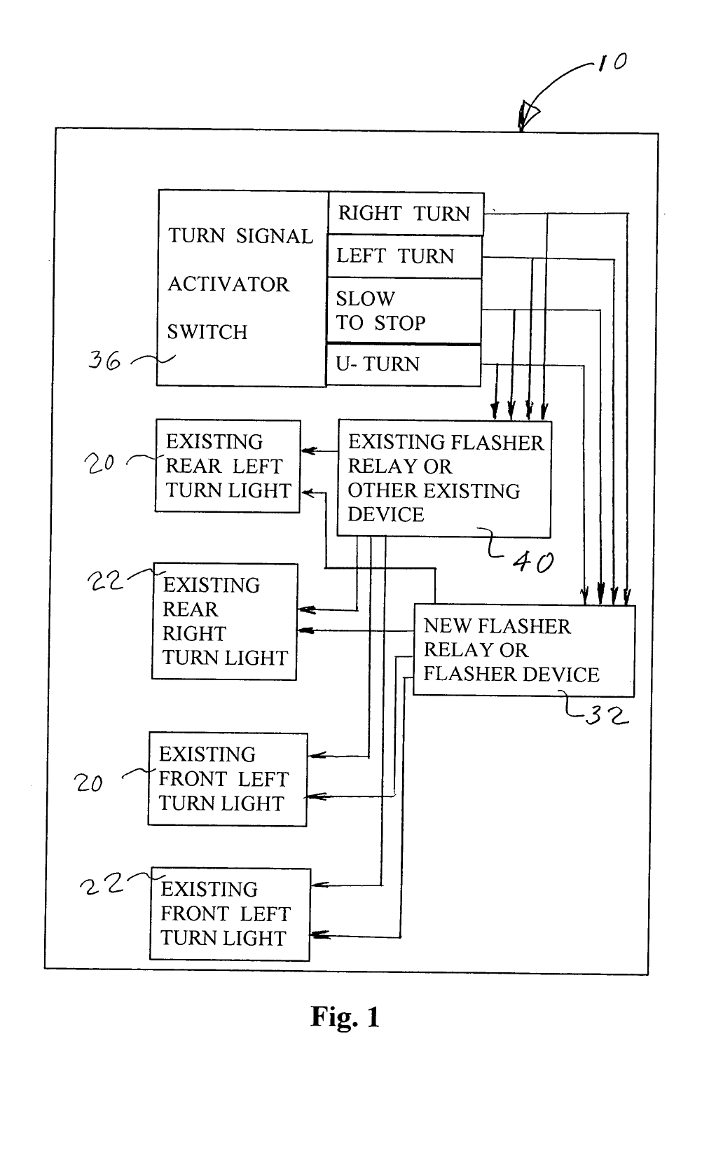

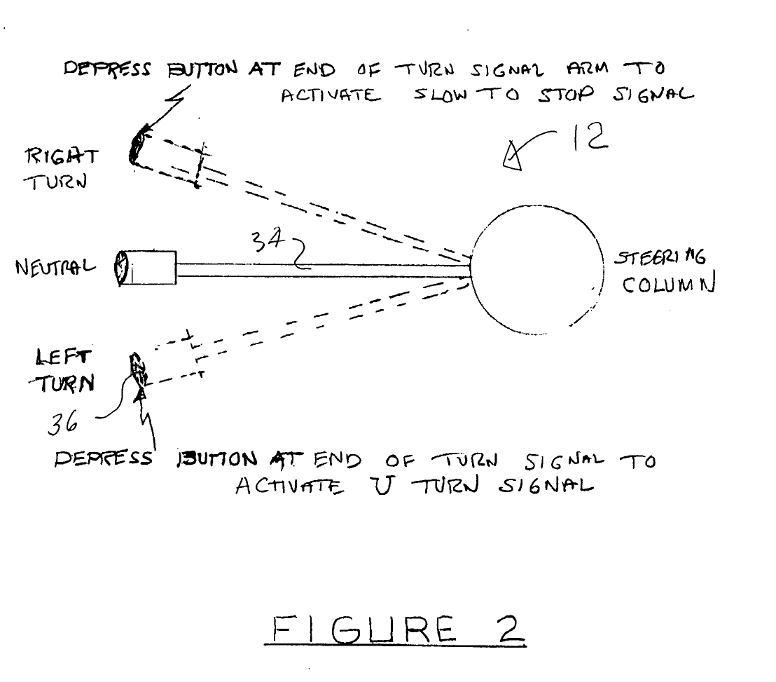

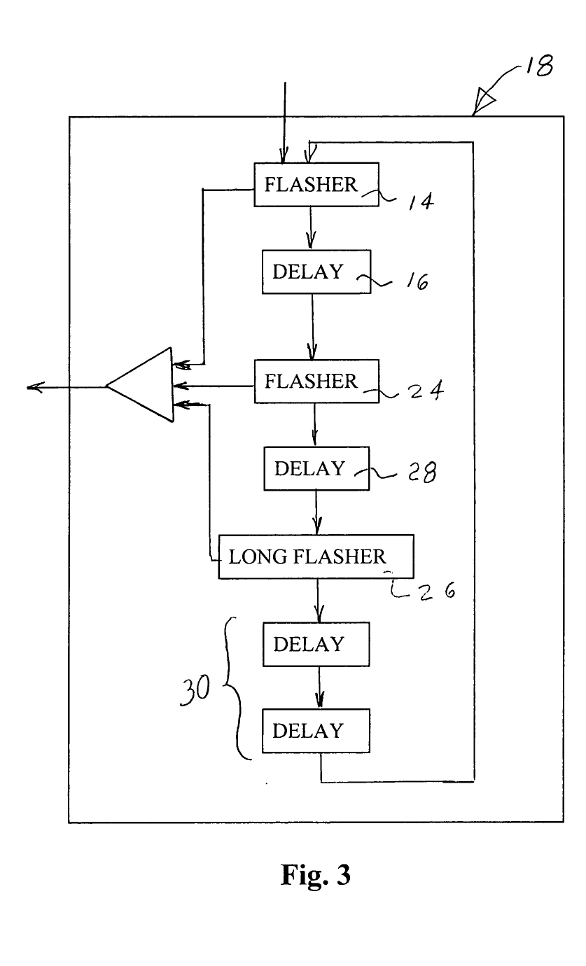

Referring now to the drawing, and in particular to FIG. 1, a turn signal circuit according to the present invention is referred to generally by reference numeral 10. Circuit 10. Referring also to FIG. 2 and FIG. 3, a turn signal device, according to the present invention, for use on a vehicle having a turn signal, includes a human operated signal initiation device 12, at least one flasher 14; and at least one delay device 16. The at least one flasher and the at least one delay device are connected in a circuit 18 which is responsive to the human operated signal initiation device. The vehicle turn signal 20 or 22 is responsive to the circuit, and the circuit causes the vehicle turn signal to operate in a manner easily distinguishable from a conventional turn signal. In one arrangement, the circuit causes the vehicle turn signal to operate in a combination of long and short light signals. In a similar arrangement, the circuit causes the vehicle turn signal to operate in a combination of long and short light signals and a combination of long and short delays between the light signals. In general, the circuit causes the vehicle turn signal to operate in a series of light signals and delays. In a preferred form, wherein the circuit causes the vehicle turn signal to operate in a repeated series of two short light signals followed by one long light signal, with short delays after the short light signals and a long delay after the long light signal. Such a signal represents the letter “U” in Morse Code. A similar code could be used for a slow-to-stop signal. In general, the U-turn signal would be on the front and rear driver side turn signal and the slow-to-stop or pull-over-to-stop signal would be on the front and rear passenger side. In one particular embodiment, the at least one flasher 14 comprises two short flashers 14 and 24 and one long flasher 26 in series. In one such embodiment, the at least one delay device 16 comprises a short delay device 16 and 28 in series with and after each of the two short flashers 14 and 24, and a long delay device 30 after the one long flasher. Normally, the long flasher is at least twice as long as a short flasher and the long delay device delays at least twice as long as a short delay device, and can be made from short delay devices in series.

In more generalized terms, a turn signal device, according to the present invention, for use on a vehicle having a turn signal, includes a human operated signal initiation device 12, and at least one flasher device 32 responsive to the human operated signal initiation device. The vehicle turn signal 20 or 22 is responsive to the at least one flasher device, operating in a manner easily distinguishable from a conventional turn signal. The at least one flasher device causes the vehicle turn signal to operate in a combination of long and short light signals. In one arrangement, the at least one flasher device causes the vehicle turn signal to operate in a combination of long and short light signals and a combination of long and short delays between the light signals, but in general, the at least one flasher device causes the vehicle turn signal to operate in a series of light signals and delays. Again, in a preferred form, the at least one flasher device causes the vehicle turn signal to operate in a repeated series of two short light signals followed by one long light signal, with short delays after the short light signals and a long delay after the long light signal.

Human operated signal initiation device 12 includes a turn signal arm 34 and a button 36 which can be depressed to activate a U-turn signal when pulled down for a left turn and a slow-to-stop signal when pulled up for a right turn. A regular turn signal or a U-turn or slow-to-stop signal all activate a turn signal activator switch 38. A normal, or preexisting flasher relay 40 activates normal turn signals when button 36 is not depressed. When button 36 is depressed and a turn signal is activated, the U-turn or slow-to-stop flasher 32 is activated.

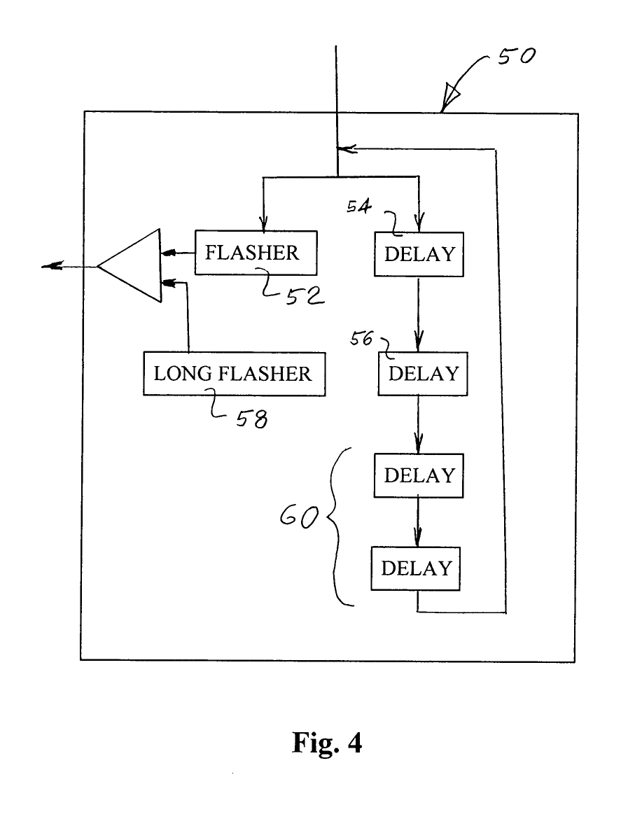

Referring now to FIG. 4, an alternative embodiment of a turn circuit according to the present invention is referred to generally by reference numeral 50. Circuit 50 includes one short flasher 52 which is initially activated and activated after delay 54. After a second delay 56, long flasher 58 is activated. Then long delay 60 cycles the process over again.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A turn signal device for use on a vehicle having a turn signal, comprising in combination:
a human operated signal initiation device;
at least one flasher; and
at least one delay device, wherein the at least one flasher and the at least one delay device are connected in a circuit responsive to the human operated signal initiation device, and wherein the vehicle turn signal is responsive to the circuit and the circuit causes the vehicle turn signal to operate in a manner easily distinguishable from a conventional turn signal.

2. A turn signal device according to claim 1, wherein the circuit causes the vehicle turn signal to operate in a combination of long and short light signals.

3. A turn signal device according to claim 1, wherein the circuit causes the vehicle turn signal to operate in a combination of long and short light signals and a combination of long and short delays between the light signals.

4. A turn signal device according to claim 1, wherein the circuit causes the vehicle turn signal to operate in a series of light signals and delays.

5. A turn signal device according to claim 1, wherein the circuit causes the vehicle turn signal to operate in a repeated series of two short light signals followed by one long light signal, with short delays after the short light signals and a long delay after the long light signal.

6. A turn signal device according to claim 1, wherein the at least one flasher comprises two short flashers and one long flasher in series.

7. A turn signal device according to claim 5, wherein the at least one delay device comprises a short delay device in series with and after each of the two short flashers and a long delay device after the one long flasher, wherein the long flasher is at least twice as long as a short flasher and the long delay device delays at least twice as long as a short delay device.

8. A turn signal device for use on a vehicle having a turn signal, comprising in combination:
a human operated signal initiation device;
at least one flasher device responsive to the human operated signal initiation device, wherein the vehicle turn signal is responsive to the at least one flasher device, operating in a manner easily distinguishable from a conventional turn signal.

9. A turn signal device according to claim 8, wherein the at least one flasher device causes the vehicle turn signal to operate in a combination of long and short light signals.

10. A turn signal device according to claim 8, wherein the at least one flasher device causes the vehicle turn signal to operate in a combination of long and short light signals and a combination of long and short delays between the light signals.

11. A turn signal device according to claim 8, wherein the at least one flasher device causes the vehicle turn signal to operate in a series of light signals and delays.

12. A turn signal device according to claim 8, wherein the at least one flasher device causes the vehicle turn signal to operate in a repeated series of two short light signals followed by one long light signal, with short delays after the short light signals and a long delay after the long light signal.
